(19) United States
(12) Patent Application Publication
(10) Pub. No.: US 2016/0211876 A1
(43) Pub. Date: Jul. 21, 2016

(54) PORTABLE TERMINAL AND CONTROL METHOD

(71) Applicant: SHARP KABUSHIKI KAISHA, Osaka (JP)

(72) Inventor: Eiji YAMAMOTO, Osaka-shi (JP)

(21) Appl. No.: 14/912,942

(22) PCT Filed: Aug. 6, 2014
(86) PCT No.: PCT/JP2014/070741

§ 371 Date: Feb. 19, 2016

(30) Foreign Application Priority Data
Sep. 20, 2013 (JP) 2013-196032

(51) Int. Cl. H04B 1/3827; H04M 1/725

(52) U.S. Cl. CPC H04B 1/3838; H04M 1/72569

(57) ABSTRACT

A portable terminal of the present invention includes an output limiting section (14) for limiting an electric wave intensity at a time when a wireless output section (16) outputs a wireless signal, in a case where (i) a proximity sensor (11) detects that the portable terminal is in proximity to an object, which proximity sensor (11) is provided on a surface of the portable terminal which surface comes in contact with or in closest proximity to the head of a user in cases where the portable terminal is in use and (ii) a grip sensor (12) detects that the portable terminal is held by a hand of a user, which grip sensor (12) is provided at a position different from a position where the proximity sensor (11) is provided.

### TECHNICAL FIELD

The present invention relates to a portable terminal including a wireless output section for outputting a wireless signal to an external device.

### BACKGROUND ART

In recent years, various wireless devices such as mobile phones and smartphones become more familiar and widespread as a communication tool, as a wireless technology advances. However, there is a concern that electric waves outputted from such wireless devices may have an adverse effect on human bodies. In order to solve this problem, conventionally, an attempt has been made to reduce an amount of electric waves to a human body, by limiting an electric wave intensity at the time when a wireless device in the proximity of a human body outputs a wireless signal. For example, Patent Literature 1 discloses a portable terminal which is arranged to include a grip sensor which detects whether a user is holding the portable terminal and to limit the electric wave intensity in a case where the grip sensor detects that a user is holding the portable terminal. Meanwhile, Patent Literature 2 discloses a portable terminal which is arranged to include a proximity sensor which detects whether or not an object is in proximity, and to limit the electric wave intensity by switching a matching circuit depending on whether the present of an object in proximity is detected or not.

### CITATION LIST

### Patent Literature

Patent Literature 1

Japanese Patent Application Publication, Tokukai, No. 2012-170071 (Publication Date: Sep. 6, 2012)

Patent Literature 2

Japanese Patent Application Publication, Tokukai, No. 2012-239108 (Publication Date: Dec. 6, 2012)

### SUMMARY OF INVENTION

### Technical Problem

However, when the electric wave intensity is limited, connectivity of the portable terminals with a base station deteriorates. Accordingly, it is preferable that the limitation of the electric wave intensity be restricted to the minimum necessary. However, in techniques disclosed in Patent Literatures 1 and 2, the electric wave intensity may be limited disadvantageously even in a case where no limitation on the electric wave intensity is necessary. Concretely, in the technique disclosed in Patent Literature 1, the electric wave intensity is limited when a user is holding the portable terminal. Accordingly, the electric wave intensity will be limited even in a case where, for example, a user is holding the portable terminal in a state in which the portable terminal is apart from a part of a human body (e.g. the head) which part may be adversely influenced by electric waves. Meanwhile, in the technique disclosed in Patent Literature 2, the electric wave intensity is limited in a case where an object is in proximity. Thus, even in a case where the portable terminal is apart from a human body, the portable terminal carries out processing for limiting the electric wave intensity if the portable terminal detects an object in the vicinity of the portable terminal.

The present invention is attained in view of the above problems. An object of the present invention is to provide a portable terminal capable of (i) correctly identifying a condition under which an electric wave intensity should be limited, and (ii) limiting the electric wave intensity under such a condition.

### Solution to Problem

In order to solve the above problem, a portable terminal in accordance with an aspect of the present invention includes: a wireless output section for outputting a wireless signal to an external device; a first sensor which detects whether the portable terminal is in contact with or in proximity to an object, the first sensor being provided in a region of a surface of the portable terminal which surface comes in contact with or in closest proximity to a head of a user in cases where the portable terminal is in use; a second sensor which detects whether the portable terminal is held by a hand of a user, the second sensor being provided at a position different from a position where the first sensor is provided; and an output limiting section for limiting an electric wave intensity at a time when the wireless output section outputs the wireless signal, in a case where (i) the first sensor detects that the portable terminal is in contact with or in proximity to an object and (ii) the second sensor detects that the portable terminal is held by a hand of a user.

In order to solve the above problem, a method for controlling a portable terminal, in accordance with an aspect of the present invention, is a method for controlling a portable terminal including a wireless output section for outputting a wireless signal to an external device, the method comprising the step of limiting an electric wave intensity at a time when the wireless output section outputs a wireless signal, in a case where (i) a first sensor detects that the portable terminal is in contact with or in proximity to an object and (ii) a second sensor detects that the portable terminal is held by a hand of a user, the first sensor detecting whether the portable terminal is in contact with or in proximity to an object, and being provided in a region of a surface of the portable terminal which surface comes in contact with or in closest proximity to a head of a user in cases where the portable terminal is in use, and the second sensor detecting whether the portable terminal is held by a hand of a user, and being provided at a position different from a position where the first sensor is provided.

### Advantageous Effects of Invention

According to an aspect of the present invention, a portable terminal in accordance with the present invention can (i) correctly identify a condition under which an electric wave intensity should be limited, and (ii) limit the electric wave intensity under such a condition.

### BRIEF DESCRIPTION OF DRAWINGS

FIG. 1 is a block diagram illustrating an arrangement of substantial part of a smartphone in accordance with Embodiment 1.

FIG. 2 is a schematic view illustrating an appearance of the smartphone in accordance with Embodiment 1.

FIG. 3 is a chart showing a relation between each condition assumed from results of detection with sensors and an electric wave intensity.

FIG. 4 is a flowchart illustrating an example flow of processing in the smartphone in accordance with Embodiment 1.

FIG. 5 is a block diagram illustrating an arrangement of substantial part of a smartphone in accordance with Embodiment 2.

FIG. 6 is a flowchart illustrating an example flow of processing in the smartphone in accordance with Embodiment 2.

FIG. 7 is a block diagram illustrating an arrangement of substantial part of a smartphone in accordance with Embodiment 3.

FIG. 8 is a flowchart illustrating an example flow of processing in the smartphone in accordance with Embodiment 3.

FIG. 9 is a schematic view illustrating an appearance of a smartphone in accordance with a modified example of Embodiment 3.

### DESCRIPTION OF EMBODIMENTS

### Embodiment 1

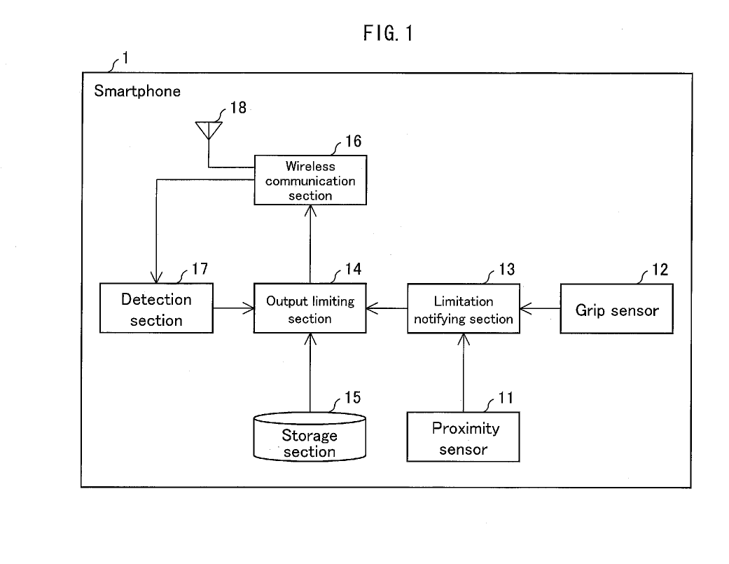

With reference to FIGS. 1 through 4, the following discusses an embodiment of the present invention. Embodiment 1 discusses an example in which the present invention is applied to a smartphone 1. Note that applications of the present invention are not limited to a smartphone. The present invention is applicable to any portable terminal capable of outputting a wireless signal to an external device. Note also that, for convenience of explanation, members having functions identical to those of respective members described in preceding Embodiment(s) are given respectively identical reference signs, and descriptions of such members are omitted as appropriate. Further, shapes and dimensions (i.e., length, size, width and/or the like) in arrangements illustrated in drawings are not ones which reflect actual shapes and dimensions, but are changed as appropriate for clarification and simplification of the drawings.

(Arrangement of Appearance of Smartphone 1)

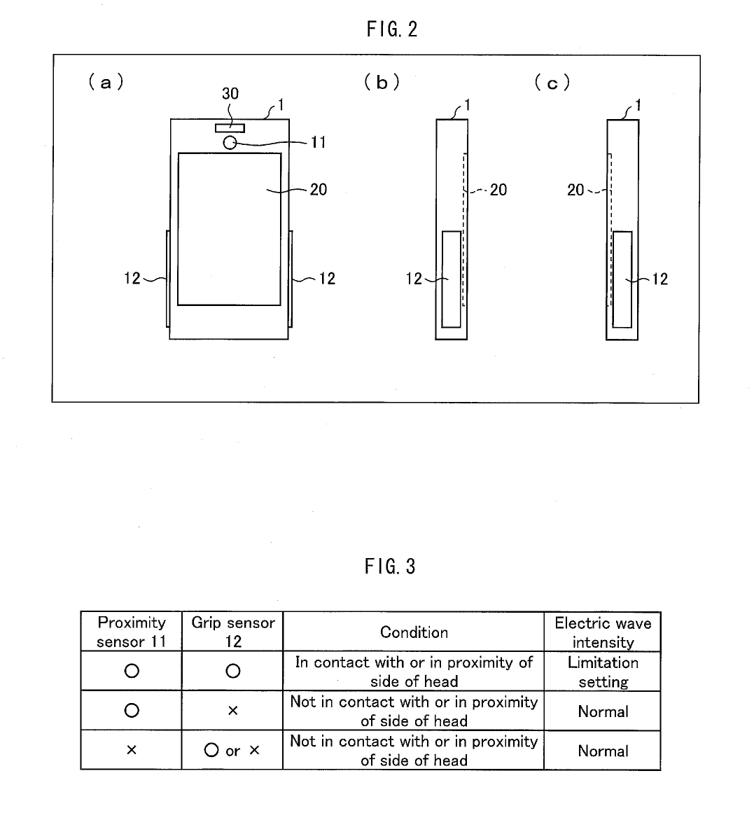

The following discusses an arrangement of an appearance of the smartphone 1, with reference to FIG. 2. FIG. 2 is a schematic view illustrating the appearance of the smartphone 1. As illustrated in (a) of FIG. 2, the smartphone 1 in accordance with Embodiment 1 includes a display section 20 on at least one surface of a housing. Note that, hereinafter, the surface provided with the display section 20 is referred to as a “front surface” of the smartphone 1, and a surface on an opposite side of the front surface is referred to as a “back surface” of the smartphone 1. The smartphone 1 in accordance with Embodiment 1 includes a proximity sensor 11 in a region of the front surface. Further, as illustrated in (a) of FIG. 2, the proximity sensor 11 is provided in the vicinity of a speaker 30. Note that the speaker 30 may also be called a “receiver”. This speaker 30 is used by a user for catching a sound from a counterpart in communication when the user talks on the smartphone 1. For this purpose, the user puts his/her ear in contact with or in the proximity of the speaker 30 when the user talks on the smartphone. This means that the proximity sensor 11 is provided at a position where the head of a user comes in closest proximity to the smartphone 1 at the time when the user talks on the smartphone 1. Therefore, the proximity sensor 11 can correctly identify whether the smartphone 1 is in proximity to the head of the user. Note that a position of the proximity sensor 11 is not limited to a position in the vicinity of the speaker 30.

Further, hereinafter, two surfaces sharing, with the front surface, respective longer sides of the front surface are referred to as “side surfaces” of the smartphone 1. As illustrated in (b) and (c) of FIG. 2, the side surfaces of the smartphone 1 in accordance with Embodiment 1 each are provided with one grip sensor 12. Note that as illustrated in (b) and (c) of FIG. 2, the grip sensor 12 is provided in a lower half part of each of the side surfaces, on an assumption that a lower side of FIG. 2 is defined as a lower side of the smartphone 1. However, the present invention is not limited to this example. The grip sensor 12 may be provided so as to extend all over each of the side surfaces or so as to extend continuously from each of the side surfaces to the back surface. The number of the grip sensor provided to each of the side surfaces is not limited to one but may be two or more.

As described above, the proximity sensor 11 is provided at a position different from a position where the grip sensor 12 is provided. Concretely, the proximity sensor 11 is provided at a position where the proximity sensor 11 does not detect a hand of a user when the user holds the smartphone 1 by his/her hand. This prevents the proximity sensor 11 from detecting a hand of a user. Accordingly, an erroneous detection of the proximity sensor 11 can be prevented.

(Overview of Functions of Smartphone 1)

Next, the following discusses an overview of functions of the smartphone 1 with reference to FIGS. 2 and 3. FIG. 3 is a chart showing a relation between each condition assumed from results of detection with sensors and an electric wave intensity. Here, the overview of the functions of the smartphone 1 is discussed by providing an example case where a user talks on the smartphone 1. When a user talks on a smartphone, the user generally holds the smartphone and brings his/her ear in contact with (or in the vicinity of) the speaker 30 as illustrated in FIG. 2. At this time, the head of the user comes in proximity to the smartphone. For such a case, for example, in Japan, it is required under Article 14-2 of Radio Equipment Regulations, to set, to 2.0 w/kg or less, a specific absorption rate (SAR) of an electric wave radiated from radio equipment to the head of a human body. Note that the SAR represents an amount of energy absorbed by 10 g of a given living tissue within an average time of 6 minutes. In other words, in the smartphone, it is required to limit an electric wave intensity to an SAR equal to or less than 2.0 w/kg, at the time when a wireless signal is outputted (e.g., while a user is talking on the smartphone).

The smartphone 1 in accordance with Embodiment 1 limits the electric wave intensity in a case where (i) the proximity sensor 11 detects the presence of an object in proximity and (ii) the grip sensor 12 detects that the smartphone 1 is held by a hand of a user. As illustrated in FIG. 2, the proximity sensor 11 is provided at a position which comes in contact with or in closest proximity to the head of a user when the user is talking on the smartphone 1 (when the smartphone is in use), more specifically, at a position in the vicinity of the speaker 30 provided in another region of the front surface of the smartphone 1. Thus, in a case where (i) the proximity sensor 11 detects the presence of an object in proximity and (ii) the grip sensor 12 detects that the smartphone 1 is held by a hand of a user, the user is probably talking on the smartphone 1. From this, it is inferred that, as shown in FIG. 3, the smartphone 1 is in contact with or in proximity to the head (ear) of a user, that is, under a condition which requires limitation on the electric wave intensity. Under this condition, the smartphone 1 limits the electric wave intensity on the basis of a limitation setting as described later.

On the other hand, as shown in FIG. 3, (i) in a case where the proximity sensor 11 does not detect the present of an object in proximity or (ii) in a case where the grip sensor 12 does not detect that the smartphone 1 is held by a hand of a user, the user is probably not talking the smartphone 1. In other words, it is inferred that the smartphone 1 is not in contact with or in proximity to a side of the head of a user. Accordingly, under this condition, the electric wave intensity will be a normal intensity without limitation at the time when the smartphone 1 outputs a wireless signal.

As described above, the smartphone 1 in accordance with Embodiment 1 can correctly identify a condition under which the electric wave intensity should be limited and a condition under which the electric wave intensity should not be limited. This makes it possible to properly limit the electric wave intensity under the condition under which the electric wave intensity should be limited.

(Arrangement of Smartphone 1)

Next, the following discusses an arrangement of substantial part of the smartphone 1 with reference to FIG. 1. FIG. 1 is a block diagram illustrating an example arrangement of substantial part of the smartphone 1. As illustrated in FIG. 1, the smartphone 1 includes at least the proximity sensor 11 (first sensor), the grip sensor 12 (second sensor), a limitation notifying section 13, an output limiting section 14, a storage section 15, a wireless communication section 16 (wireless output section), a detection section 17, and an antenna 18.

The proximity sensor 11 detects the presence of an object in the proximity of the smartphone 1 (an object in proximity). For example, the proximity sensor 11 may be a ranging sensor which measures a distance to an object around the smartphone 1. Concretely, the proximity sensor 11 may be any sensor capable of at least detecting whether the head of a user comes in proximity to the smartphone 1 to an extent that an influence of an electric wave is non-negligible. Note that that a state in which “the head of a user comes in proximity to the smartphone 1 to an extent that an influence of an electric wave is non-negligible” means, for example, a state where a distance between the smartphone 1 and a side (ear) of the head of the user is approximately 2 cm or less. In this case, the proximity sensor 11 only needs to be capable of detecting an object at a distance of 2 cm or less from the proximity sensor 11. The proximity sensor 11 also outputs a detection result to the limitation notifying section 13.

As described earlier, the proximity sensor 11 is provided at a position different from a position where the grip sensor 12 is provided, so as not to detect a hand of a user in contact with the grip sensor 12. Further, as described earlier, the proximity sensor 11 is provided in a region of a surface which comes in contact with or in closest proximity to the head of a user when the user talks on the smartphone 1. Furthermore, it is preferable that the proximity sensor 11 be provided in the vicinity of the speaker 30, because a user brings his/her head in closest proximity to an area around the speaker 30 when the user talks on the smartphone 1.

The grip sensor 12 detects a contact with an object such as a hand of a user. The grip sensor 12 also outputs a detection result to the limitation notifying section 13. The grip sensor 12 may be, for example, a capacitance sensor or a pressure sensor. The grip sensor 12 is not limited in type of detection methods, as long as the grip sensor 12 can detect a contact with an object. This makes it possible to increase sensor options for the grip sensor 12 in view of a mounting area (or a size), cost, and power consumption. Further, FIG. 2 illustrates, as an example, a case where the grip sensor 12 is provided on each of both the side surfaces of the smartphone 1. However, the present invention is not limited to the above example of FIG. 2. The grip sensor 12 only needs to be capable of detecting whether the smartphone 1 is held by a user. For example, the grip sensor 12 may be provided on either one of the side surfaces of the smartphone 1.

The limitation notifying section 13 notifies an instruction to limit the electric wave intensity, in accordance with the detection results of the proximity sensor 11 and the grip sensor 12. Concretely, the limitation notifying section 13 notifies, to the output limiting section 14, an instruction to limit the electric wave intensity of a wireless signal to be outputted from the smartphone 1, in a case where (i) the proximity sensor 11 outputs a detection result indicating that an object is detected and (ii) the grip sensor 12 outputs a detection result indicating that the smartphone 1 is held by a hand of a user. Note that the limitation notifying section 13 can alternatively be expressed as a determination section, which determines that the electric wave intensity of a wireless signal to be outputted from the smartphone 1 should be limited and then notifies, to the output limiting section 14, an instruction to limit the electric wave intensity, in a case where (i) the proximity sensor 11 outputs a detection result indicating that an object is detected and (ii) the grip sensor 12 outputs a detection result indicating that the smartphone 1 is held by a hand of a user. Meanwhile, in a case where (i) the proximity sensor 11 does not output a detection result indicating that an object in proximity is present or (ii) the grip sensor 12 does not output a detection result indicating that the smartphone 1 is held by a hand of a user (a contact with an object), the limitation notifying section 13 may determine that the present electric wave intensity should be maintained. Also in this point, the limitation notifying section 13 can be expressed as a determination section. In this case, the limitation notifying section 13 ends an electric wave intensity limiting processing as described later.

The output limiting section 14, having received a notification from the limitation notifying section 13, limits the electric wave intensity of a wireless signal to be outputted from the smartphone 1. Concretely, when the limitation notifying section 13 notifies, to the output limiting section 14, an instruction to limit the electric wave intensity, the output limiting section 14 reads out a limitation setting as described later from the storage section 15, and then limits the electric wave intensity on the basis of the limitation setting. More concretely, the output limiting section 14 monitors a value of the electric wave intensity that is notified from the detection section 17, and controls the wireless communication section 16 so that a maximum power for transmitting a wireless signal (a maximum transmission power) may not exceed a set value on the basis of the limitation setting. Note that on the basis of a correspondence between a voltage value of an electric wave intensity control circuit (not illustrated) provided to the wireless communication section 16 and a value of the electric wave intensity, the output limiting section 14 may control the electric wave intensity controlling circuit so that the voltage value may stay lower than the set value on the basis of the limitation setting.

The storage section 15 stores a setting for a case where a limitation is imposed on the electric wave intensity at the time when the smartphone 1 outputs a wireless signal. Concretely, the storage section 15 stores a setting (limitation setting) of a maximum transmission power in a case where the electric wave intensity is limited. The limitation setting may be, for example, in Japan, a setting of a maximum transmission power with which setting the SAR does not exceed 2.0 w/kg. The storage section 15 may be, for example, a memory itself as hardware. Alternatively, the storage section 15 may be a storage region in a memory, or a database for storing threshold values which database is formed in the storage section.

The wireless communication section 16 outputs (transmits) a wireless signal to an external device via the antenna 18, and receives, through the antenna 18, a wireless signal transmitted from an external device. In a case where the wireless communication section 16 outputs a wireless signal, an electric wave intensity of such output is controlled by the output limiting section 14 as described earlier. For example, the wireless communication section 16 is controlled by the output limiting section 14 so that the maximum transmission power in outputting a wireless signal may not exceed a set value on the basis of a limitation setting. The wireless communication section 16 may be implemented as a set of various types of hardware related to wireless communications, or may be a combination of hardware and software which controls at least part of the hardware.

The detection section 17 measures a value of the electric wave intensity of a wireless signal outputted from the wireless communication section 16. The detection section 17 then outputs thus measured value of the electric wave intensity to the output limiting section 14. The detection section 17 may be implemented as hardware such as a detection circuit, or may be a combination of hardware and software which controls at least part of the hardware.

(Flow of Processing in Smartphone 1)

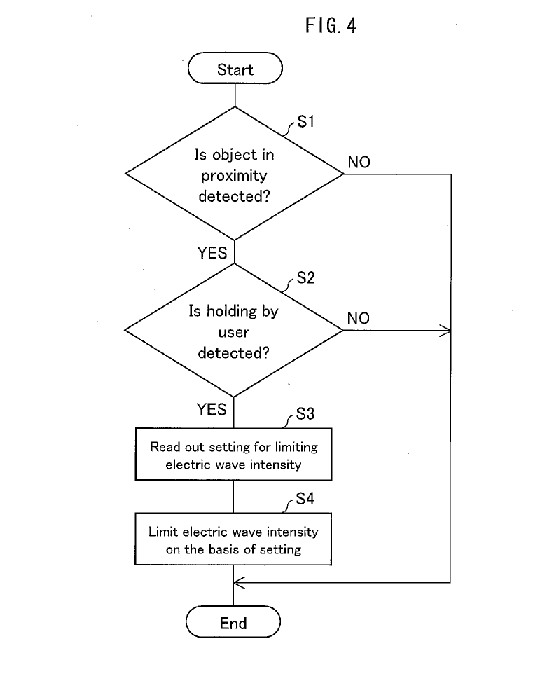

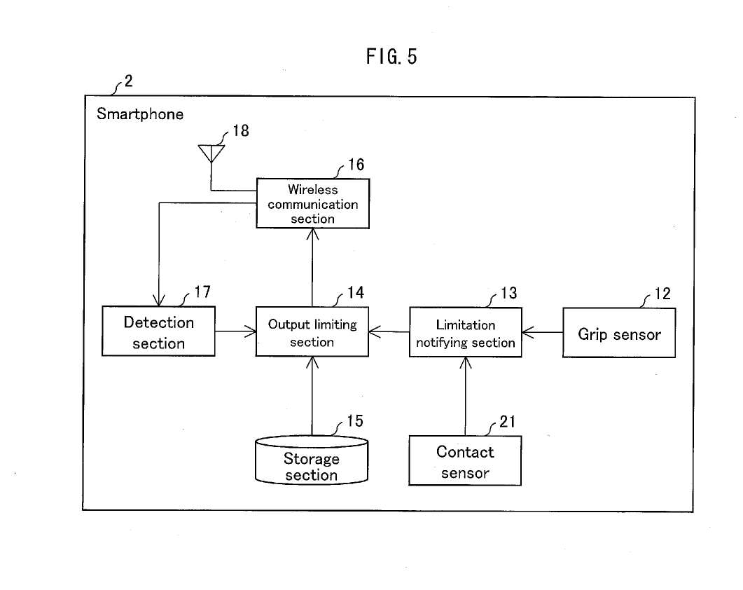

Next, the following discusses a flow of processing (electric wave intensity limiting processing) in the smartphone 1 with reference to FIG. 4. FIG. 4 is a flowchart illustrating the flow of processing in the smartphone 1. Note that FIG. 4 illustrates a flow of processing in the smartphone 1 which has been activated.

Firstly, in a case where (i) the proximity sensor 11 outputs, to the limitation notifying section 13, a detection result indicating the presence of an object in proximity (YES at S1) and (ii) the grip sensor 12 outputs, to the limitation notifying section 13, a detection result indicating that the smartphone 1 is held by a hand of a user (a contact with an object) (YES at S2), a limitation should be imposed on the electric wave intensity at the time when the wireless communication section 16 outputs a wireless signal. Accordingly, the limitation notifying section 13 notifies, to the output limiting section 14, an instruction to limit the electric wave intensity.

Then, the output limiting section 14 reads out a setting for limiting the electric wave intensity (S3). Concretely, the output limiting section 14 reads out a limitation setting from the storage section 15. The output limiting section 14 then limits the electric wave intensity on the basis of the limitation setting that the output limiting section 14 has read out (S4: output limiting step). Concretely, the output limiting section 14 monitors a value of the electric wave intensity which value is supplied from the detection section 17. Subsequently, the output limiting section 14 controls the wireless communication section 16 so that a maximum power (maximum transmission power) for transmitting the wireless signal may not exceed a set value on the basis of the limitation setting. The electric wave intensity limiting processing ends here.

On the other hand, (i) in a case where the proximity sensor 11 does not output, to the limitation notifying section 13, a detection result indicating the presence of an object in proximity (NO at S1) or (ii) in a case where the grip sensor 12 does not output, to the limitation notifying section 13, a detection result indicating that the smartphone 1 is held by a hand of a user (a contact with an object) (NO at S2), the present electric wave intensity should be maintained. In other words, the electric wave intensity may stay normal. Therefore, the limitation notifying section 13 ends the electric wave intensity limiting processing.

Note that though not shown in FIG. 4, (i) in a case where the proximity sensor 11 no longer detects the presence of an object in proximity while the electric wave intensity is being limited or (ii) in a case where the grip sensor 12 no longer detects that the smartphone 1 is held by a hand of a user (a contact with an object) while the electric wave intensity is being limited, the limitation notifying section 13 may notify, to the output limiting section 14, an instruction to cancel a limitation on the electric wave intensity. In this case, the output limiting section 14 cancels the limitation on output and puts the electric wave intensity back to a normal electric wave intensity.

(Effects)

As described above, the smartphone 1 in accordance with Embodiment 1 includes (i) the proximity sensor 11 in the vicinity of the speaker 30 and (ii) the grip sensor 12 on each of the side surfaces of the smartphone 1. This allows (i) the proximity sensor 11 to detect that the head (ear) of a user is in contact with or in proximity to the smartphone 1, in a case where the user talks on the smartphone 1 and (ii) the grip sensor 12 to detect that the smartphone 1 is held by a hand of a user, in the same case. In this way, when the user talks on the smartphone 1, it is possible to detect not only (i) that the head (ear) of a user is in contact with or in proximity to the smartphone 1 but also (ii) that the smartphone 1 is head by a hand of a user. This allows the limitation notifying section 13 to correctly identify a condition in which the user is talking on the smartphone 1. This means that the limitation notifying section 13 can correctly identify a condition under which a limitation should be imposed on the electric wave intensity at the time when the smartphone 1 outputs a wireless signal because the smartphone 1 is outputting wireless signals in the vicinity of the head of a user. Then, having identified the above condition, the limitation notifying section 13 notifies, to the output limiting section 14, an instruction to limit the electric wave intensity. Consequently, the output limiting section 14 limits the electric wave intensity. As described above, the smartphone 1 in accordance with Embodiment 1 can correctly identify a condition under which the electric wave intensity should be limited, and can limit the electric wave intensity under such a condition.

### Embodiment 2

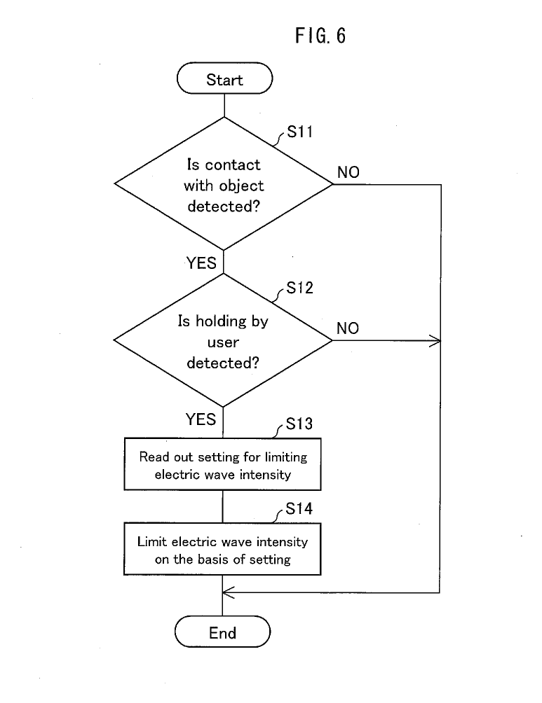

The following discusses another embodiment of the present invention with reference to FIGS. 5 and 6. FIG. 5 is a block diagram illustrating an example arrangement of substantial part of a smartphone 2 in accordance with Embodiment 2. The smartphone 2 in accordance with Embodiment 2 includes a contact sensor 21 in place of a proximity sensor 11 provided in a smartphone 1 in accordance with Embodiment 1.

The contact sensor 21 detects a contact with an object. Concretely, the contact sensor 21 is provided on a surface (in the vicinity of a speaker 30) of the smartphone 2 which surface comes in contact with the head of a user when the user talks on the smartphone 2. Then, the contact sensor 21 detects, for example, a contact between the smartphone 2 and the ear of the user. As a method of detecting such a contact, the contact between the smartphone 2 and the ear of the user may be detected as a change in pressure in a case where a pressure sensor is used as the contact sensor 21. Alternatively, the contact between the smartphone 2 and the ear of the user may be detected as a change in capacitance in a case where a capacitance sensor is used as the contact sensor 21. The contact sensor 21 also outputs a detection result to a limitation notifying section 13. Note that the contact sensor 21 may be the same type of sensor as a grip sensor 12.

(Flow of Processing in Smartphone 2)

Next, the following discusses a flow of processing (electric wave intensity limiting processing) in the smartphone 2 with reference to FIG. 6. FIG. 6 is a flowchart illustrating the flow of processing in the smartphone 2. Note that FIG. 6 illustrates a flow of processing in the smartphone 2 which has been activated.

In a case where (i) the contact sensor 21 outputs, to a limitation notifying section 13, a detection result indicating a contact with an object (YES at S11) and (ii) the grip sensor 12 outputs, to the limitation notifying section 13, a detection result indicating that the smartphone 2 is held by a hand of a user (a contact with an object) (YES at S12), a limitation should be imposed on an electric wave intensity at the time when a wireless communication section 16 outputs a wireless signal. Accordingly, the limitation notifying section 13 notifies, to an output limiting section 14, an instruction to limit the electric wave intensity.

Processing at S13 and S14 subsequent to S12 is similar to processing at S3 and S4 in FIG. 4, and therefore, a description thereof is omitted here.

Note that (i) in a case where the contact sensor 21 does not output, to the limitation notifying section 13, a detection result indicating a contact with an object (NO at S11) or (ii) in a case where the grip sensor 12 does not output, to the limitation notifying section 13, a detection result indicating that the smartphone 2 is held by a hand of a user (a contact with an object) (NO at S12), the present electric wave intensity should be maintained. In other words, the electric wave intensity may stay normal. Therefore, the limitation notifying section 13 ends the electric wave intensity limiting processing.

Note that though not shown in FIG. 6, (i) in a case where the contact sensor 21 no longer detects a contact with an object while the electric wave intensity is being limited or (ii) in a case where the grip sensor 12 no longer detects that the smartphone 2 is held by a hand of a user (a contact with an object) while the electric wave intensity is being limited, the limitation notifying section 13 may notify, to the output limiting section 14, an instruction to cancel a limitation on the electric wave intensity. In this case, the output limiting section 14 cancels the limitation on output and puts the electric wave intensity back to a normal electric wave intensity.

(Effects)

As described above, the smartphone 2 in accordance with Embodiment 2 includes the contact sensor 21 in the vicinity of the speaker 30. When a user talks on the smartphone 2, the user is highly likely to put his/her ear in contact with the smartphone 2. Thus, the contact sensor 21 can detect, in the vicinity of the speaker 30, a contact between the smartphone 2 and the head (ear) of a user in a case where the user talks on the smartphone 2.

### Embodiment 3

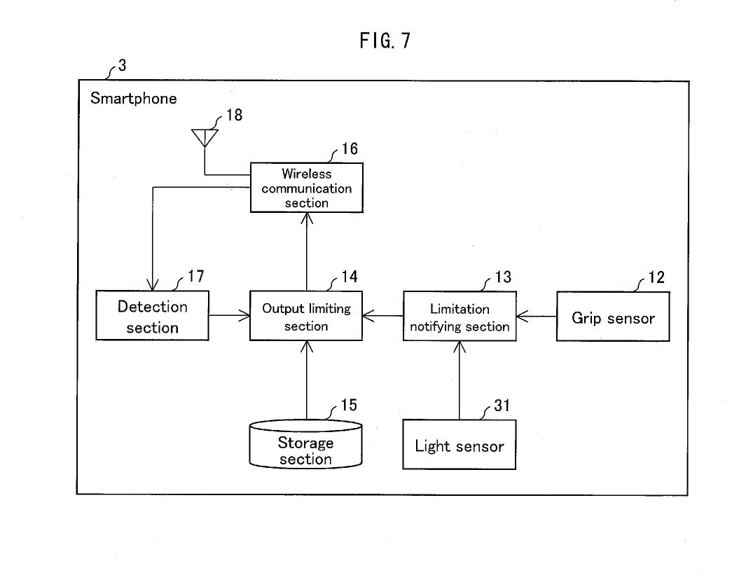

The following discusses yet another embodiment of the present invention with reference to FIGS. 7 through 9. FIG. 7 is a block diagram illustrating an example arrangement of substantial part of a smartphone 3 in accordance with Embodiment 3. The smartphone 3 in accordance with Embodiment 3 includes a light sensor 31 in place of a proximity sensor 11 provided in a smartphone 1 in accordance with Embodiment 1.

The light sensor 31 detects brightness in an area surrounding the light sensor 31. Concretely, the light sensor 31 is provided on a surface (in the vicinity of a speaker 30) of the smartphone 3 which surface comes in contact with (or in proximity to) the head of a user when the user talks on the smartphone 3. Then, the light sensor 31 detects brightness in the vicinity of the speaker 30. The light sensor 31 also outputs a detection result to a limitation notifying section 13. For example, the light sensor 31 may always measure a brightness in the vicinity of the speaker 30 and output a measurement result (detection result) to the limitation notifying section 13. The following discussion assumes a case where the light sensor 31 always measures a brightness in the vicinity of the light sensor 31.

(Flow of Processing in Smartphone 3)

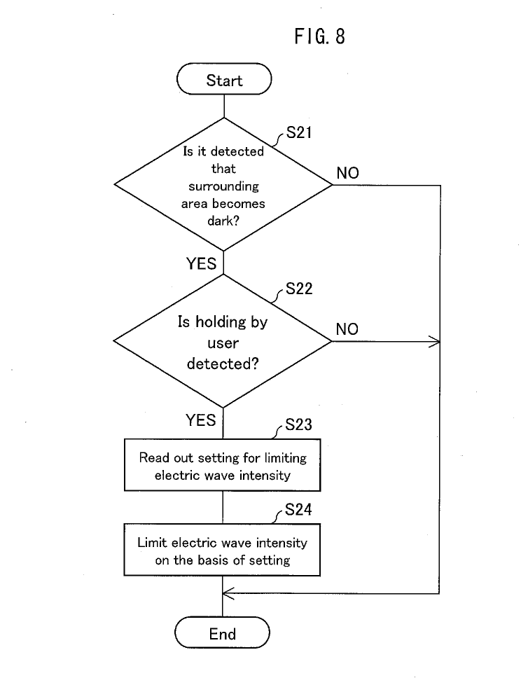

Next, the following discusses a flow of processing (electric wave intensity limiting processing) in the smartphone 3 with reference to FIG. 8. FIG. 8 is a flowchart illustrating the flow of the processing in the smartphone 3. Note that FIG. 8 illustrates a flow of processing in the smartphone 3 which has been activated.

In a case where (i) the light sensor 31 outputs, to the limitation notifying section 13, the most recent measurement result on the brightness in the area surrounding the light sensor 31, and the most recent measurement result indicates that the area is darker as compared to the brightness indicated by an immediately preceding measurement result (YES at S21) and (ii) a grip sensor 12 outputs, to the limitation notifying section 13, a detection result indicating that the smartphone 3 is held by a hand of a user (a contact with an object) (YES at S22), a limitation should be imposed on an electric wave intensity at the time when a wireless communication section 16 outputs a wireless signal. Accordingly, the limitation notifying section 13 notifies, to an output limiting section 14, an instruction to limit the electric wave intensity. Note that “the most recent measurement result (on the brightness in the area surrounding the light sensor 31) indicates that the area is darker as compared to the brightness indicated by an immediately preceding measurement result” means that, for example, a value obtained by subtracting a value of the immediately preceding measurement result from a value of the most recent measurement result in regard to the brightness in the area surrounding the light sensor 31 is equal to or less than a preset negative value. Further, processing of the limitation notifying section 13 is not limited to the above example. For example, the limitation notifying section 13 may notify, to the output limiting section 14, an instruction to limit the electric wave intensity in a case where (i) the most recent measurement result outputted from the light sensor 31 has a value equal to or less than a preset threshold and (ii) the grip sensor 12 outputs a detection result indicating that the smartphone 3 is held by a hand of a user (a contact with an object).

Processing at S23 and S24 subsequent to S22 are similar to processing at S3 and S4 in FIG. 4, and therefore, a description thereof is omitted here.

Note that (i) in a case where the light sensor 31 outputs, to the limitation notifying section 13, the most recent measurement result on the brightness in the area surrounding the light sensor 31 and a value obtained by subtracting a value of the immediately preceding measurement result from a value of the most recent measurement result is more than the preset negative value (NO at S21) or (ii) in a case where the grip sensor 12 does not output, to the limitation notifying section 13, a detection result indicating that the smartphone 3 is held by a hand of a user (a contact with an object) (NO at S22), the present electric wave intensity should be maintained. In other words, the electric wave intensity may stay normal. Therefore, the limitation notifying section 13 ends the electric wave intensity limiting processing.

Note that though not shown in FIG. 8, (i) in a case where while the electric wave intensity is being limited, the light sensor 31 outputs the most recent measurement result on the brightness in the area surrounding the light sensor 31 and the most recent measurement result indicates that the area is brighter as compared to the brightness indicated by an immediately preceding measurement result or (ii) in a case where the grip sensor 12 no longer detects that the smartphone 3 is held by a hand of a user (a contact with an object) while the electric wave intensity is being limited, the limitation notifying section 13 may notify, to the output limiting section 14, an instruction to cancel a limitation on the electric wave intensity. In this case, the output limiting section 14 cancels the limitation on output and puts the electric wave intensity back to a normal electric wave intensity. Note that “the most recent measurement result (on the brightness in the area surrounding the light sensor 31) indicates that the area is brighter as compared to the brightness indicated by an immediately preceding measurement result” means that, for example, a value obtained by subtracting a value of the immediately preceding measurement result from a value of the most recent measurement result in regard to the brightness in the area surrounding the light sensor 31 is equal to or more than a preset positive value.

(Effects)

As described above, the smartphone 3 in accordance with Embodiment 3 includes the light sensor 31 in the vicinity of the speaker 30. When a user talks on the smartphone 3, the user puts his/her ear in contact with (or in proximity to) the smartphone 3. Accordingly, as to the brightness, the area around the speaker 30 becomes darker as compared to other part of the smartphone 3. In other words, it is possible to identify a state in which the smartphone 2 is in contact with (or in the proximity of) the head (ear) of a user in the vicinity of the speaker 30, by identifying, on the basis of the measurement result (detection result) of the light sensor 31, a state in which an area in the vicinity of the speaker 30 becomes dark.

Further, in general, a smartphone is often provided with a light sensor on a front surface (a surface provided with a display section such as a liquid crystal display) of the smartphone, for the purpose of reducing current consumption in the display section. Accordingly, there is no need to newly provide another light sensor 31 for the purpose of realizing the present invention. In other words, not only reduction of the current consumption at the display section but also limitation on an electric wave intensity can be implemented by providing the light sensor 31 in the vicinity of the speaker 30. This makes it possible to reduce cost for the smartphone 3.

### Modified Example of Embodiment 3

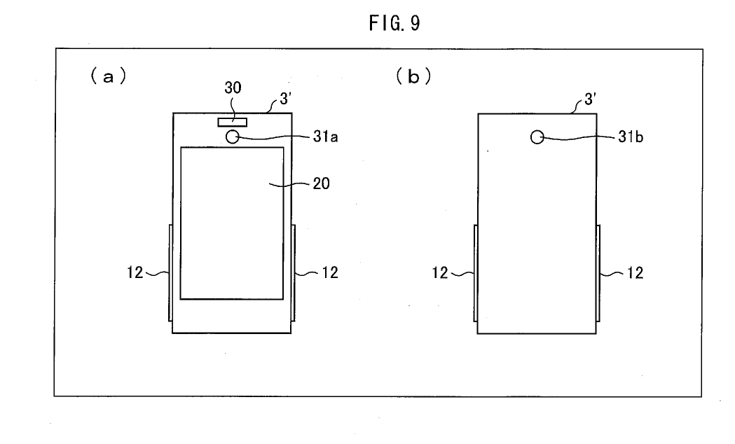

Next, the following discusses a modified example of Embodiment 3 with reference to FIG. 9. FIG. 9 is a schematic view illustrating an appearance of a smartphone 3′. As illustrated in (a) of FIG. 9, the smartphone 3′ is provided with a light sensor 31a in the vicinity of a speaker 30. Further, as illustrated in (b) of FIG. 9, the smartphone 3′ is also provided with a light sensor 31b on a back surface of the smartphone 3′. Note that the light sensors 31a and 31b each can be the same type of sensor as a light sensor 31 described above in Embodiment 3.

A limitation notifying section 13 compares respective measurement results (detection results) on brightness in areas surrounding the light sensors 31a and 31b which detection results are supplied from the light sensors 31a and 31b, respectively. Then, in a case where (i) a value of the measurement result of the light sensor 31a is smaller than a value of the detection result of the light sensor 31b and (ii) a grip sensor 12 outputs a detection result indicating that the smartphone 3′ is held by a hand of a user (a contact with an object), the limitation notifying section 13 notifies, to an output limiting section 14, an instruction to limit an electric wave intensity at the time when a wireless communication section 16 outputs a wireless signal.

In the above arrangement, when a user is talking on the smartphone 3′, the area surrounding the light sensor 31a is darker because the light sensor 31a is in contact with or in the proximity of the ear of the user. Meanwhile, the area surrounding the light sensor 31b is often brighter than the area surrounding the light sensor 31a. Accordingly, it is possible to identify a state in which the smartphone 2 is in contact with (or in the proximity of) the head (ear) of a user in the vicinity of the speaker 30, by identifying a state in which the area surrounding the light sensor 31a is darker than the area surrounding the light sensor 31b.

[Software Implementation Example]

Control blocks of the smartphones 1 through 3 and 3′ (particularly, the limitation notifying section 13 and the output limiting section 14) may be realized by a logic circuit (hardware) provided in an integrated circuit (IC chip) or the like or may be realized by software as executed by a CPU (Central Processing Unit).

In the latter case, the smartphones 1 through 3 and 3′ each include: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Overview]

A portable terminal (smartphones 1 through 3 and 3′) in accordance with Aspect 1 of the present invention includes: a wireless output section (wireless communication section 16) for outputting a wireless signal to an external device; a first sensor (proximity sensor 11, contact sensor 21, and light sensor 31) which detects whether the portable terminal is in contact with or in proximity to an object, the first sensor being provided in a region of a surface of the portable terminal which surface comes in contact with or in closest proximity to a head of a user in cases where the portable terminal is in use; a second sensor (grip sensor 12) which detects whether the portable terminal is held by a hand of a user, the second sensor being provided at a position different from a position where the first sensor is provided; and an output limiting section (output limiting section 14) for limiting an electric wave intensity at a time when the wireless output section outputs the wireless signal, in a case where (i) the first sensor detects that the portable terminal is in contact with or in proximity to an object and (ii) the second sensor detects that the portable terminal is held by a hand of a user.

In the above arrangement, the first sensor is provided to the surface which may come in contact with or in closest proximity to the head of a user, while the second sensor is provided at a position different from a position where the first sensor is provided. Then, in a case where (i) the first sensor detects that the portable terminal is in contact with or in proximity to an object and (ii) the second sensor detects that the portable terminal is held by a hand of a user, the output limiting section limits an electric wave intensity at the time when a wireless signal is outputted.

In the above arrangement, in cases where a user uses the portable terminal as a phone so as to talk on the phone, (i) the first sensor can detect that the portable terminal is in contact with or in proximity to the head of the user and (ii) the second sensor can detect that the portable terminal is held by the hand of the user. In this way, when the user talks on the phone by use of the portable terminal, it is possible to detect not only (i) that the portable terminal is in contact with or in proximity to the head of the user but also (ii) that the portable terminal is held by the hand of the user. This makes it possible to correctly identify a condition in which the user is talking on the phone by use of the portable terminal. This means that it is possible to correctly identify a condition under which a limitation should be imposed on the electric wave intensity at the time when the portable terminal outputs a wireless signal because the portable terminal outputs the wireless signal in the vicinity of the head of the user. As described above, it is possible to correctly identify a condition under which the electric wave intensity should be limited, and thereby to limit the electric wave intensity under such a condition.

A portable terminal in accordance with Aspect 2 of the present invention may be arranged such that, in Aspect 1, the first sensor is provided in one region farther from a ground between two equal regions which are obtained by equally dividing the surface of the portable terminal into two regions by an axis parallel to a short side of the surface, the surface of the portable terminal coming in contact with or in closest proximity to a head of a user in cases where the portable terminal is in use.

According to the above arrangement, the first sensor is provided in one region (an upper-half region) farther from the ground between two equal regions which are obtained by equally dividing the surface (front surface) of the portable terminal into two regions by an axis parallel to a short side of the surface, which surface of the portable terminal comes in contact with or in closest proximity to a head of a user in cases where the portable terminal is in use. Generally, when the user uses a portable terminal as a phone and talks on the phone, the user often puts his/her head (ear) in contact with or in the proximity of the upper-half region of the front surface. This means that the first sensor is provided at a position of the portable terminal which position is closer to a position that comes in contact with or in closest proximity to the head of a user in cases where the user uses the portable terminal as a phone and talks on the phone. This makes it possible to more correctly identify a condition under which the electric wave intensity should be limited.

A portable terminal in accordance with Aspect 3 of the present invention may be arranged to further include, in Aspect 1 or 2, a speaker in another region of the surface which comes in contact with or in closest proximity to a head of a user in cases where the portable terminal is in use, the first sensor being provided in the vicinity of the speaker on the portable terminal.

According to the above arrangement, the first sensor is provided in the vicinity of the speaker provided to the surface of the portable terminal which surface comes in contact with or in closest proximity to the head of a user in cases where the portable terminal is in use. Generally, when the user uses a portable terminal (talks on the portable terminal as a phone), the user often puts his/her head (ear) in contact with or in the proximity of a position where the speaker is provided. This means that the position of the first sensor substantially coincides with the position of the portable terminal which position of the portable terminal comes in contact with or in closest proximity to the head of a user, in cases where the user uses the portable terminal (talks on the portable terminal as a phone). This makes it possible to more correctly identify a condition under which the electric wave intensity should be limited.

A portable terminal in accordance with Aspect 4 of the present invention may be arranged such that, in any of Aspects 1 through 3, the second sensor is provided on at least one of two surfaces of the portable terminal each of which two surfaces shares, with the surface, a long side of the surface which comes in contact with or in closest proximity to a head of a user in cases where the portable terminal is in use.

According to the above arrangement, the second sensor is provided on at least one of the two surfaces of the portable terminal each of which two surfaces shares, with the surface, the long side of the surface which comes in contact with or in closest proximity to the head of a user in cases where the portable terminal is in use. Accordingly, the second sensor is provided at a position which is highly likely to come in contact with a hand of a user when the user holds the portable terminal. This makes it possible to correctly detect whether the smartphone 1 is held by a user.

A portable terminal in accordance with Aspect 5 of the present invention may be arranged such that, in any of Aspects 1 through 4, the first sensor is the proximity sensor 11 which detects whether the portable terminal is in contact with or in proximity to an object.

A portable terminal in accordance with Aspect 6 of the present invention may be arranged such that, in any of Aspects 1 through 4, the first sensor is the contact sensor 21 which detects whether the portable terminal is in contact with an object.

A portable terminal in accordance with Aspect 7 of the present invention may be arranged such that, in any of Aspects 1 through 4, the first sensor is the light sensor 31 which detects brightness around the light sensor 31.

A portable terminal in accordance with Aspect 8 of the present invention is a method for controlling a portable terminal including a wireless output section for outputting a wireless signal to an external device, the method comprising the step (S5) of limiting an electric wave intensity at a time when the wireless output section outputs a wireless signal, in a case where (i) a first sensor detects that the portable terminal is in contact with or in proximity to an object and (ii) a second sensor detects that the portable terminal is held by a hand of a user, the first sensor detecting whether the portable terminal is in contact with or in proximity to an object, and being provided in a region of a surface of the portable terminal which surface comes in contact with or in closest proximity to a head of a user in cases where the portable terminal is in use, and the second sensor detecting whether the portable terminal is held by a hand of a user, and being provided at a position different from a position where the first sensor is provided.

The above arrangement provides the same effects as Aspect 1 described above.

### INDUSTRIAL APPLICABILITY

The present invention is applicable to a portable terminal which includes a wireless output section for outputting a wireless signal to an external device, and is particularly suitable for a portable terminal, such as a smartphone, having a communication function.

### REFERENCE SIGNS LIST

1 to 3, 3′ Smartphone (Portable terminal)
11 Proximity sensor (First sensor)
12 Grip sensor (Second sensor)
14 Output limiting section
16 Wireless communication section (Wireless output section)
21 Contact sensor (First sensor)
30 Speaker
31 Light sensor (First sensor)
S5 Output limiting step

1. A portable terminal comprising:
a wireless output section for outputting a wireless signal to an external device;
a first sensor which detects whether the portable terminal is in contact with or in proximity to an object, the first sensor being provided in a region of a surface of the portable terminal which surface comes in contact with or in closest proximity to a head of a user in cases where the portable terminal is in use;
a second sensor which detects whether the portable terminal is held by a hand of a user, the second sensor being provided at a position different from a position where the first sensor is provided; and
an output limiting section for limiting an electric wave intensity at a time when the wireless output section outputs the wireless signal, in a case where (i) the first sensor detects that the portable terminal is in contact with or in proximity to an object and (ii) the second sensor detects that the portable terminal is held by a hand of a user.

2. The portable terminal as set forth in claim 1, wherein the first sensor is provided in one region farther from a ground between two equal regions which are obtained by equally dividing the surface of the portable terminal into two regions by an axis parallel to a short side of the surface, the surface of the portable terminal coming in contact with or in closest proximity to a head of a user in cases where the portable terminal is in use.

3. The portable terminal as set forth in claim 1, further comprising a speaker in another region of the surface which comes in contact with or in closest proximity to a head of a user in cases where the portable terminal is in use,
the first sensor being provided in the vicinity of the speaker on the portable terminal.

4. The portable terminal as set forth in claim 1, wherein the second sensor is provided on at least one of two surfaces of the portable terminal each of which two surfaces shares, with the surface, a long side of the surface which comes in contact with or in closest proximity to a head of a user in cases where the portable terminal is in use.

5. A method for controlling a portable terminal including a wireless output section for outputting a wireless signal to an external device, the method comprising the step of limiting an electric wave intensity at a time when the wireless output section outputs a wireless signal, in a case where (i) a first sensor detects that the portable terminal is in contact with or in proximity to an object and (ii) a second sensor detects that the portable terminal is held by a hand of a user,
the first sensor detecting whether the portable terminal is in contact with or in proximity to an object, and being provided in a region of a surface of the portable terminal which surface comes in contact with or in closest proximity to a head of a user in cases where the portable terminal is in use, and
the second sensor detecting whether the portable terminal is held by a hand of a user, and being provided at a position different from a position where the first sensor is provided.
